(19) United States
(12) Patent Application Publication
(10) Pub. No.: US 2022/0256562 A1
(43) Pub. Date: Aug. 11, 2022

(54) METHODS OF RESOLVING COLLISION BETWEEN SR AND PUSCH

(71) Applicant: Telefonaktiebolaget LM Ericsson (publ), Stockholm (SE)

(72) Inventors: Ali BEHRAVAN, Stockholm (SE); Zhenhua ZOU, Solna (SE); Yufei BLANKENSHIP, Kildeer, IL (US); Jonas FRÖBERG OLSSON, Ljungsboro (SE)

(21) Appl. No.: 17/627,023

(22) PCT Filed: Jul. 17, 2020
(86) PCT No.: PCT/EP2020/070271

§ 371 Date: Jan. 13, 2022

Related U.S. Application Data
(60) Provisional application No. 62/875,630, filed on Jul. 18, 2019.

(51) Int. Cl. H04W 72/12

(52) U.S. Cl. CPC H04W 72/1242; H04W 72/1268

(57) ABSTRACT

A method, system and apparatus are disclosed. According to one or more embodiments, a wireless device configured to communicate with a network node is provided. The wireless device includes processing circuitry configured to resolve a scheduling overlap between at least one physical uplink control channel, PUCCH, resource configured for a scheduling request and at least one physical uplink shared channel, PUSCH, resource of a PUSCH based at least on at least one criterion.

### TECHNICAL FIELD

The present disclosure relates to wireless communications, and in particular, to resolving a resource overlap between a physical uplink control channel (PUCCH) and a physical uplink shared channel (PUSCH) if a scheduling request (SR) has been triggered.

### BACKGROUND

The new radio (NR) (also referred to as “5G”) standard in Third Generation Partnership Projection (3GPP) is designed to provide service for multiple use cases such as enhanced mobile broadband (eMBB), ultra-reliable and low latency communication (URLLC), and machine type communication (MTC). Each of these services has different technical requirements. For example, a general requirement for eMBB is high data rate with moderate latency and moderate coverage, while URLLC service may require a low latency and high reliability transmission but perhaps for moderate data rates.

One of the solutions for low latency data transmission is shorter transmission time intervals. In NR in addition to transmission in a slot, a mini-slot transmission is also allowed to reduce latency. A radio resource in NR with subcarrier spacing of 15 kHz is illustrated in FIG. 1. A mini-slot is a concept that is used in scheduling. For NR Release 15 (Rel-15), in the Downlink (DL) a min-slot can consist of 2, 4 or 7 Orthogonal Frequency-Division Multiplexing (OFDM) symbols, while in the Uplink (UL) a mini-slot can be any number of 1 to 14 OFDM symbols. The concepts of slot and mini-slot may not be specific to a specific service meaning that a mini-slot may be used for either eMBB, URLLC, or other services.

Uplink Control Information

Uplink control information (UCI) may be carried either by physical uplink control channel (PUCCH) or physical uplink shared channel (PUSCH). UCI contains one or several uplink control information, i.e., DL acknowledgement (acknowledgement (ACK)/negative acknowledgement (NACK)), channel quality indicator (CQI) or scheduling request (SR).

UCI may be transmitted on the PUSCH if the wireless device transmits user/wireless device data in the UL. In this case, PUCCH may not be allowed to be transmitted. When there is no user data to be transmitted, UCI is carried by PUCCH.

Scheduling Request

Scheduling request (SR) is sent/transmitted on a physical UL control channel (PUCCH) by a wireless device to request for a grant for UL transmission, when the wireless device has data to transmit, but does not have a grant already. The SR is sent on preconfigured and periodically occurring PUCCH dedicated to the wireless device.

The procedure for sending a SR is that when data is generated on higher layers by a logical channel, a scheduling request is triggered such as by the wireless device with associated SR configuration. Each SR configuration corresponds to one or more logical channels, and each logical channel may be mapped to zero or one SR configuration, which is configured by RRC.

The Radio Resource Configuration (RRC) configuration for scheduling request resource configuration which maps a scheduling request Identifier/Identification (ID) to SR resource configuration is shown below.

SchedulingRequestResourceConfig information element

--ASN1START
--TAG-SCHEDULING-REQUEST-RESOURCE-CONFIG-START

| SchedulingRequestResourceConfig ::= | SEQUENCE { | |
|---|---|---|
| schedulingRequestResourceId | SchedulingRequestResourceId, | |
| schedulingRequest ID | SchedulingRequestId, | |
| periodicity AndOffset | CHOICE { | |
| sym2 | | NULL, |
| sym6or7 | | NULL, |
| sl1 | | NULL, |
| sl2 | | INTEGER (0..1), |
| sl4 | | INTEGER (0..3), |
| s15 | | INTEGER (0..4), |
| sl8 | | INTEGER (0..7), |
| sl10 | | INTEGER (0..9), |
| sl16 | | INTEGER (0..15), |
| sl20 | | INTEGER (0..19), |
| sl40 | | INTEGER (0..39), |
| sl80 | | INTEGER (0..79), |
| sl160 | | INTEGER (0..159), |
| sl320 | | INTEGER (0..319), |
| sl640 | | INTEGER (0..639) |
| } | | OPTIONAL - Need M |
| Resource | PUCCH-ResourceId | OPTIONAL - Need M |

}
--TAG-SCHEDULING-REQUEST-RESOURCE-CONFIG-STOP
--ASN1STOP

*****

Hybrid Automatic Repeat Request (HARQ) Feedback

A procedure for receiving downlink transmission may include that the wireless device first monitors and decodes a PDDCH in slot n which points to a DL data scheduled in slot n+K0 slots (K0 is larger than or equal to 0). The wireless device then decodes the data in the corresponding PDSCH. Finally, based on the outcome of the decoding the wireless device sends an acknowledgement of the correct decoding (ACK) or a negative acknowledgement (NACK) to the network node at time slot n+K0+K1. Both of K0 and K1 are indicated in the downlink DCI. The resources for sending the acknowledgement are indicated by PUCCH resource indicator (PRI) field in PDCCH which points to one of PUCCH resources that is configured by higher layers. Depending on DL/UL slot configurations, or whether carrier aggregation, or per code-block group (CBG) transmission used in the DL, the feedback for several PDSCHs may need to be multiplexed in one feedback. This is done by constructing HARQ-ACK codebooks.

Channel State Information

Channel state information (CSI) is used to inform the network node about the channel quality in the DL. CSI can be sent by the wireless device periodically, semipersistently, or aperiodically. A periodic CSI report may only be transmitted in PUCCH, semi-persistent CSI report is transmitted on PUCCH or PUSCH, and aperiodic CSI report may only be transmitted on PUSCH. The PUCCH resources for semi-persistent CSI and periodic CSI are configured by RRC. The PUSCH resources for semi-persistent CSI and aperiodic CSI are scheduled dynamically via DCI.

Overlapping Between Resources for UCI and PUSCH

There can be cases/situations where UL data and UL control information have overlapping resources. This may be due to that some of the resources are scheduled dynamically, while others are configured by semi-static configuration. One example is when a dynamic UL data transmission is scheduled, a scheduling request is triggered by higher layers and is passed down to physical layer to be sent on preconfigured resources that overlap in time with the PUSCH transmission.

Overlapping Between SR and UL-SCH

In NR Rel-15, the triggered scheduling request might not be sent if the allocated PUCCH resource overlaps an ongoing UL-SCH transmission. As stated in one or more wireless communication standards, such as in clause 5.4.4 of 3GPP Technical Specification (TS) 38.321v15.5.0 (2019-03), one of the conditions to instruct the physical layer to signal the SR on one valid PUCCH resource for SR is that the PUCCH resource for the SR transmission occasion does not overlap with a UL-SCH resource. Clause 5.4.4. of 3GPP TS 38.321 generally describes as follows:

As long as at least one SR is pending, the Medium Access Control (MAC) entity may for each pending SR:

1> if the MAC entity has no valid PUCCH resource configured for the pending SR:
2> initiate a Random Access procedure (as described in subclause 5.1 of 3GPP TS 38.321) on the SpCell and cancel the pending SR.

1> else, for the SR configuration corresponding to the pending SR:
2> when the MAC entity has an SR transmission occasion on the valid PUCCH resource for SR configured; and
2> if sr-ProhibitTimer is not running at the time of the SR transmission occasion; and
2> if the PUCCH resource for the SR transmission occasion does not overlap with a measurement gap; and
2> if the PUCCH resource for the SR transmission occasion does not overlap with a UL-SCH resource:
   3> if SR_COUNTER <sr-TransMax:
      4> increment SR_COUNTER by 1;
      4> instruct the physical layer to signal the SR on one valid PUCCH resource for SR;
      4> start the sr-ProhibitTimer.
   3> else:
      4> notify RRC to release PUCCH for all Serving Cells;
      4> notify RRC to release SRS for all Serving Cells;
      4> clear any configured downlink assignments and uplink grants;
      4> clear any PUSCH resources for semi-persistent CSI reporting;
      4> initiate a Random Access procedure (as described in subclause 5.1 of 3GPP TS 38.321) on the SpCell and cancel all pending SRs. In other words, if a configured PUCCH resource for SR transmission does not overlap with a UL-SCH resource per the italicized condition above, then SR may be transmitted, but Clause 5.4.4. of 3GPP TS 38.321 fails to address the situation where an overlap exist with a configured PUCCH resource for SR transmission and a UL-SCH resource.NOTE: The selection of which valid PUCCH resource for SR to signal SR on when the MAC entity has more than one overlapping valid PUCCH resource for the SR transmission occasion is left to wireless device implementation.

In NR, there is a mapping between the logical channel and the SR configuration. Since this is a high priority logical channel, it is expected that the network node allocate frequent PUCCH resources for the transmission of SR. The above description states that the SR can only be transmitted on the first PUCCH resource after UL-SCH. This may introduce unnecessary latency and may lead to that the latency target of this logical channel not being met.

In the industrial IoT (IIoT) Work item, one of the objectives is to address UL data/control and control/control resource collision by specifying one or more methods to address resource collision between SR associating to high-priority traffic and uplink data of lower-priority traffic for the cases where MAC determines the prioritization.

Therefore, how to handle/resolve the collision between a SR and UL-SCH resource in existing systems is not clear.

### SUMMARY

Some embodiments advantageously provide methods, systems, network nodes and wireless devices for resolving a resource overlap between a physical uplink control channel (PUCCH) and a physical uplink shared channel (PUSCH) if a scheduling request (SR) has been triggered and/or configured in the PUCCH.

One or more methods are described for resolving collision between SR and UL SCH. More specifically the disclosure describes solutions to puncture PUSCH or rate-match PUSCH or drop PUSCH at the physical layer. Which solution to apply may depend on at least one criterion such as, for example, whether the UL-SCH is a dynamic grant or a configured grant and/or whether the DMRS part of the PUSCH is impacted (punctured or not).

According to one aspect of the disclosure, a wireless device configured to communicate with a network node is provided. The wireless device includes processing circuitry (84) configured to: resolve a scheduling overlap between at least one physical uplink control channel, PUCCH, resource configured for a scheduling request and at least one physical uplink shared channel, PUSCH, resource of a PUSCH based at least on at least one criterion.

According to one or more embodiments of this aspect, the resolving of the scheduling overlap includes one of dropping the scheduling request and causing transmission of the scheduling request. According to one or more embodiments of this aspect, the at least one criterion is based at least on a priority level of a logical channel that triggered the scheduling request and a highest priority level of at least one logical channel on the PUSCH. According to one or more embodiments of this aspect, the at least one criterion is based at least on a periodicity of the scheduling request and a periodicity of a grant for the PUSCH.

According to one or more embodiments of this aspect, the at least one criterion is met based on a periodicity of the scheduling request being lower than a periodicity of a grant for the PUSCH. According to one or more embodiments of this aspect, the scheduling overlap is resolved by dropping the scheduling request based the at least one criterion being met. According to one or more embodiments of this aspect, the at least one criterion is based at least on a joint processing time for processing the scheduling request and PUSCH.

According to one or more embodiments of this aspect, the at least one criterion is met based on there being sufficient time to multiplex the scheduling request onto the PUSCH. According to one or more embodiments of this aspect, based on the at least one criterion being met, the processing circuitry is configured to: cancel the scheduling request and cause transmission of the PUSCH; and cancel transmission of at least a portion of the PUSCH and cause transmission of the scheduling request. According to one or more embodiments of this aspect, the cancelling of the transmission of at least the portion of the PUSCH includes one of: cancelling the at least the portion of the PUSCH that includes overlapping symbols with scheduling request, the transmission of the PUSCH configured to resume after transmission of the scheduling request; cancelling the at least the portion of the PUSCH that includes overlapping symbols with the scheduling request and subsequent PUSCH symbols, the at least the portion of the PUSCH including a demodulation reference signal, DMRS; and cancelling the at least the portion of the PUSCH that includes overlapping symbols with the scheduling request and subsequent PUSCH symbols while preserving a DMRS for transmission.

According to one or more embodiments of this aspect, the resolving the scheduling overlap includes the processing circuitry being configured to multiplex the scheduling request on the PUSCH based at least on a priority level of the scheduling request. According to one or more embodiments of this aspect, one of: the scheduling request is multiplexed without other uplink control information, UCI, types based on the priority level; the scheduling request is multiplexed with a Hybrid automatic repeat request-acknowledgement, HARQ-ACK, based on a number of HARQ-ACK bits; and the scheduling request is multiplexed based on a PUCCH format of the PUCCH.

According to another aspect of the disclosure, a network node configured to communicate with a wireless device is provided. The network node includes processing circuitry configured to: receive a scheduling request based at least in part on a resolved scheduling overlap between at least one physical uplink control channel, PUCCH, resource configured for a scheduling request and at least one physical uplink shared channel, PUSCH, resource of a PUSCH, the resolved scheduling overlap being based at least on at least one criterion.

According to one or more embodiments of this aspect, the at least one criterion is based at least on a priority level of a logical channel that triggered the scheduling request and a highest priority level of at least one logical channel on the PUSCH. According to one or more embodiments of this aspect, the at least one criterion is based at least on a periodicity of the scheduling request and a periodicity of a grant for the PUSCH. According to one or more embodiments of this aspect, the at least one criterion is met based on a periodicity of the scheduling request being lower than a periodicity of a grant for the PUSCH.

According to one or more embodiments of this aspect, the at least one criterion is based at least on a joint processing time for processing the scheduling request and PUSCH. According to one or more embodiments of this aspect, the at least one criterion is met based on there being sufficient time to multiplex the scheduling request onto the PUSCH. According to one or more embodiments of this aspect, the scheduling request is multiplexed on the PUSCH based at least on a priority level of the scheduling request.

According to one or more embodiments of this aspect, one of: the scheduling request is multiplexed without other uplink control information, UCI, types based on the priority level; the scheduling request is multiplexed with a Hybrid automatic repeat request-acknowledgement, HARQ-ACK, based on a number of HARQ-ACK bits; and the scheduling request is multiplexed based on a PUCCH format of the PUCCH.

According to another aspect of the disclosure, a method implemented by a wireless device that is configured to communicate with a network node is provided. A scheduling overlap between at least one physical uplink control channel, PUCCH, resource configured for a scheduling request and at least one physical uplink shared channel, PUSCH, resource of a PUSCH is resolved based at least on at least one criterion.

According to one or more embodiments of this aspect, the resolving of the scheduling overlap includes one of dropping the scheduling request and causing transmission of the scheduling request. According to one or more embodiments of this aspect, the at least one criterion is based at least on a priority level of a logical channel that triggered the scheduling request and a highest priority level of at least one logical channel on the PUSCH. According to one or more embodiments of this aspect, the at least one criterion is based at least on a periodicity of the scheduling request and a periodicity of a grant for the PUSCH.

According to one or more embodiments of this aspect, the at least one criterion is met based on a periodicity of the scheduling request being lower than a periodicity of a grant for the PUSCH. According to one or more embodiments of this aspect, the scheduling overlap is resolved by dropping the scheduling request based the at least one criterion being met. According to one or more embodiments of this aspect, the at least one criterion is based at least on a joint processing time for processing the scheduling request and PUSCH.

According to one or more embodiments of this aspect, the at least one criterion is met based on there being sufficient time to multiplex the scheduling request onto the PUSCH. According to one or more embodiments of this aspect, based on the at least one criterion being met, one of: the scheduling request is cancelled and transmission of the PUSCH is caused; transmission of at least a portion of the PUSCH is cancelled and transmission of the scheduling request is caused. According to one or more embodiments of this aspect, the cancelling of the transmission of at least the portion of the PUSCH includes one of: cancelling the at least the portion of the PUSCH that includes overlapping symbols with scheduling request, the transmission of the PUSCH configured to resume after transmission of the scheduling request; cancelling the at least the portion of the PUSCH that includes overlapping symbols with the scheduling request and subsequent PUSCH symbols, the at least the portion of the PUSCH including a demodulation reference signal, DMRS; and cancelling the at least the portion of the PUSCH that includes overlapping symbols with the scheduling request and subsequent PUSCH symbols while preserving a DMRS for transmission.

According to one or more embodiments of this aspect, the resolving the scheduling overlap includes the processing circuitry being configured to multiplex the scheduling request on the PUSCH based at least on a priority level of the scheduling request. According to one or more embodiments of this aspect, one of: the scheduling request is multiplexed without other uplink control information, UCI, types based on the priority level; the scheduling request is multiplexed with a Hybrid automatic repeat request-acknowledgement, HARQ-ACK, based on a number of HARQ-ACK bits; and the scheduling request is multiplexed based on a PUCCH format of the PUCCH.

According to another aspect of the disclosure, a method implemented by a network node that is configured to communicate with a wireless device is provided. A scheduling request based at least in part on a resolved scheduling overlap between at least one physical uplink control channel, PUCCH, resource configured for a scheduling request and at least one physical uplink shared channel, PUSCH, resource of a PUSCH is received where the resolved scheduling overlap is based at least on at least one criterion.

According to one or more embodiments of this aspect, the at least one criterion is based at least on a priority level of a logical channel that triggered the scheduling request and a highest priority level of at least one logical channel on the PUSCH. According to one or more embodiments of this aspect, the at least one criterion is based at least on a periodicity of the scheduling request and a periodicity of a grant for the PUSCH. According to one or more embodiments of this aspect, the at least one criterion is met based on a periodicity of the scheduling request being lower than a periodicity of a grant for the PUSCH.

According to one or more embodiments of this aspect, the at least one criterion is based at least on a joint processing time for processing the scheduling request and PUSCH. According to one or more embodiments of this aspect, the at least one criterion is met based on there being sufficient time to multiplex the scheduling request onto the PUSCH. According to one or more embodiments of this aspect, the scheduling request is multiplexed on the PUSCH based at least on a priority level of the scheduling request. According to one or more embodiments of this aspect, one of: the scheduling request is multiplexed without other uplink control information, UCI, types based on the priority level; the scheduling request is multiplexed with a Hybrid automatic repeat request-acknowledgement, HARQ-ACK, based on a number of HARQ-ACK bits; and the scheduling request is multiplexed based on a PUCCH format of the PUCCH.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a radio resource in NR with subcarrier spacing of 15 kHz;

FIG. 2 is a schematic diagram of an exemplary network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a flowchart of an example process in a network node according to some embodiments of the present disclosure;

FIG. 9 is a flowchart of another example process in a network node according to some embodiments of the present disclosure;

FIG. 10 is a flowchart of an example process in a wireless device according to some embodiments of the present disclosure;

FIG. 11 is a flowchart of another example process in a wireless device according to some embodiments of the present disclosure;

FIG. 12 is a diagram of examples of resolving a resource collision between SR and PUSCH;

FIG. 13 is a block diagram of PUCCH carrying SR cancelling PUSCH transmission in overlapping symbols;

FIG. 14 is a block diagram of PUCCH carrying SR that cancels PUSCH transmission in the overlapping symbols and any subsequent PUSCH symbols;

FIG. 15 is a block diagram of the PUCCH carrying SR that cancels PUSCH transmission in the overlapping symbols and any subsequent PUSCH symbols where DMRS is preserved;

FIG. 16 is a diagram of SR multiplexed with PUSCH;

FIG. 17 is a block diagram of SR multiplexed with PUSCH where PUSCH is punctured by SR; and

FIG. 18 is a block diagram of SR multiplexed with PUSCH where PUSCH is rate matched around SR.

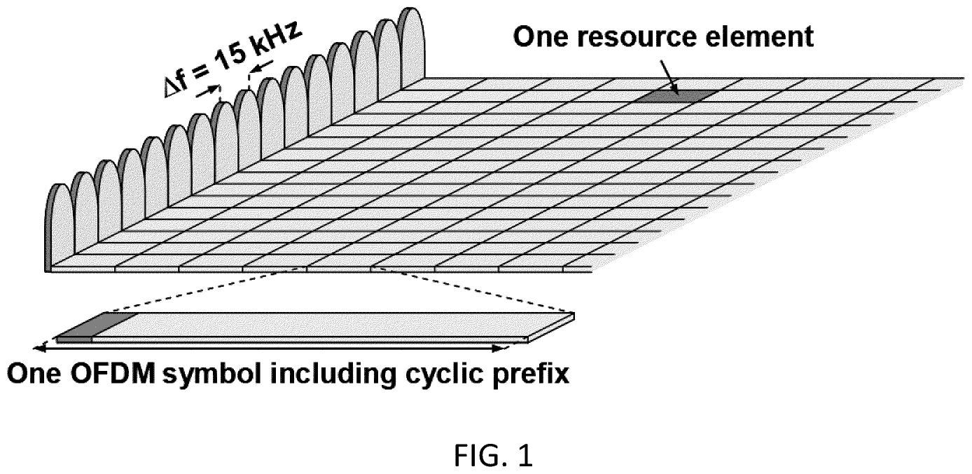

### DETAILED DESCRIPTION

Existing solution(s) described above fail to consider how to resolve collisions between SR and UL-SCH (also referred to as a physical uplink shared channel (PUSCH)). Further, these existing solution(s) do not support, in general, collision between control information and data with different priorities. For example, if a SR is triggered when the MAC Protocol Data Unit (PDU) for UL SCH is ready to be transmitted, there can be collision between physical resources for transmission of both of them. This becomes particularly important if they have different priorities, for example, a time critical SR that has to be transmitted as early as possible requires a faster transmission compared to a PUSCH that is not as urgent. Therefore, if sending SR on an overlapping UL-SCH resource is needed, then how to handle the collision between SR and UL-SCH resources is not clear.

The disclosure advantageously solves the problems with existing systems and arrangements by providing one or more methods for handling/resolving the collision (i.e., resource overlap) between SR and UL-SCH resources.

Before describing in detail exemplary embodiments, it is noted that the embodiments reside primarily in combinations of apparatus components and processing steps related to resolving a resource overlap between a physical uplink control channel (PUCCH) and a physical uplink shared channel (PUSCH) if a scheduling request (SR) has been triggered.

Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “resource”, as used herein, is intended to be interpreted in a general way. It may indicate an arbitrary combination of subcarriers, time slots, codes and spatial dimensions.

In one or more embodiments, the term “scheduling overlap” may refer to a situation where the same physical resource is scheduled for use by two different logical channels such as a physical uplink control channel and a physical uplink shared channel, and/or where the physical resource is scheduled for use for different data such as shared channel data and control information data. Scheduling overlap may result in collision between physical resources.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

Generally, with puncturing, the information related to a physical channel or signal is mapped to resource elements in the normal way; and in a second step those resource elements that should be empty or carry information related to another physical channel or signal—such as a PUSCH signaling—are set to zero and/or replaced by the other channels/signals information such as a scheduling request or PUCCH signaling. In other words, puncturing means that the transmitter deletes the modulation symbols (from a first channel) originally mapped to the punctured resource elements and replaces it with modulation symbols corresponding to the second signal.

Generally, with rate matching, the resource elements that should be empty/used by another channel/signal are already mapped around during the mapping operation (and by that not deleting, as with puncturing). In other words, rate matching means that the transmitter considers from the beginning that some resource elements are used for the second signal and does not put information from the first channel on these resource elements. The transmitter produces viewer coded bits corresponding to the amount of resource elements that are needed for the second signal. The transmitter puts the second signal on the resource elements that were left empty by the first channel.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide for resolving a resource overlap between a physical uplink control channel (PUCCH) and a physical uplink shared channel (PUSCH) if a scheduling request (SR) has been triggered.

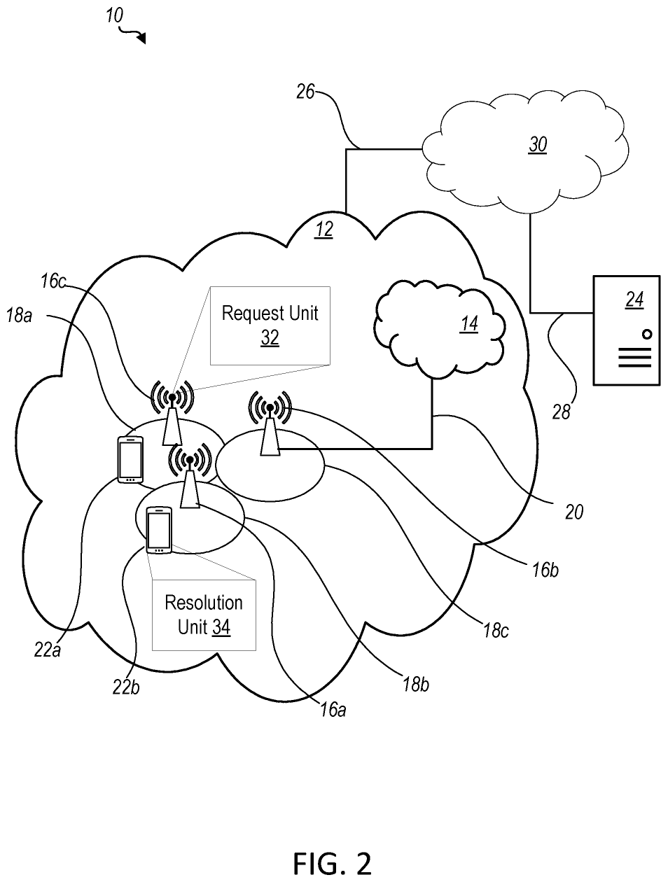

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a request unit 32 which is configured to perform one or more network node 16 function described herein such as with respect to receiving signaling based on resolving a resource overlap between a physical uplink control channel (PUCCH) and a physical uplink shared channel (PUSCH) if a scheduling request (SR) has been triggered. A wireless device 22 is configured to include a resolution unit 34 which is configured to perform one or more wireless device 22 functions as described herein such as with respect to resolving a resource overlap between a physical uplink control channel (PUCCH) and a physical uplink shared channel (PUSCH) if a scheduling request (SR) has been triggered.

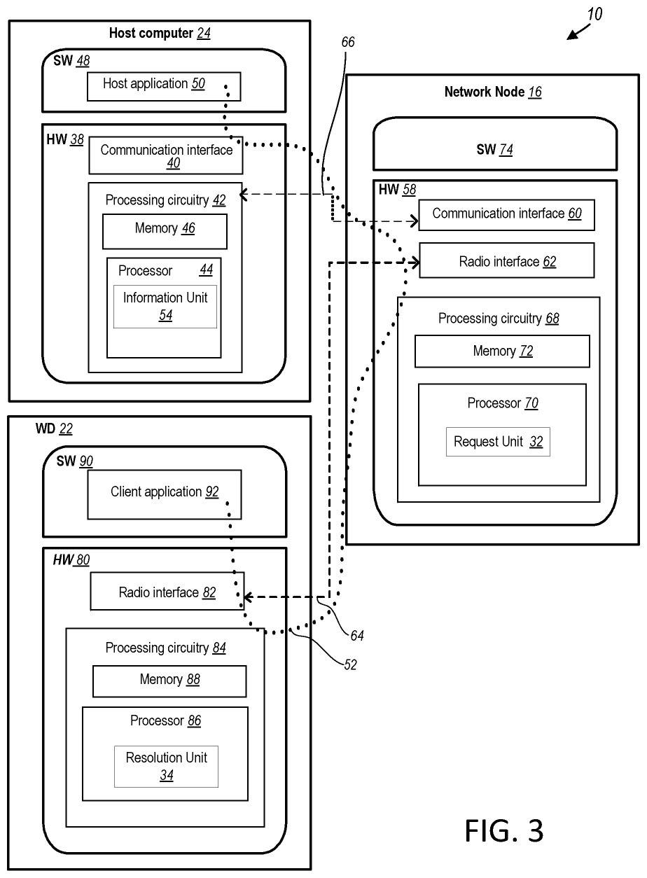

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to process, determine, transmit, receiving, store, communicate, relay, forward, etc. information related to resolving a resource overlap between a physical uplink control channel (PUCCH) and a physical uplink shared channel (PUSCH) if a scheduling request (SR) has been triggered.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include request unit 32 configured to perform one or more network node 16 functions as described herein such as with respect to a resolved resource overlap between a PUCCH and a PUSCH if a SR has been triggered, as described herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a resolution unit 34 configured to perform one or more wireless device 22 functions as described herein such as with respect to resolving a resource overlap between a PUCCH and a PUSCH if a SR has been triggered.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as request unit 32, and resolution unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

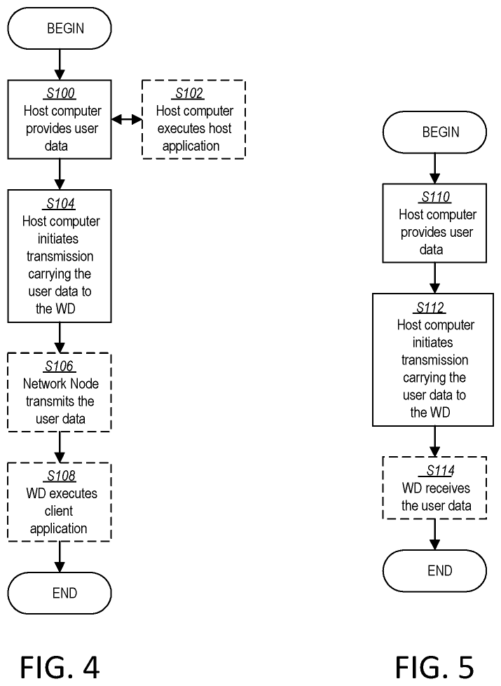

FIG. 4 is a flowchart illustrating an exemplary method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

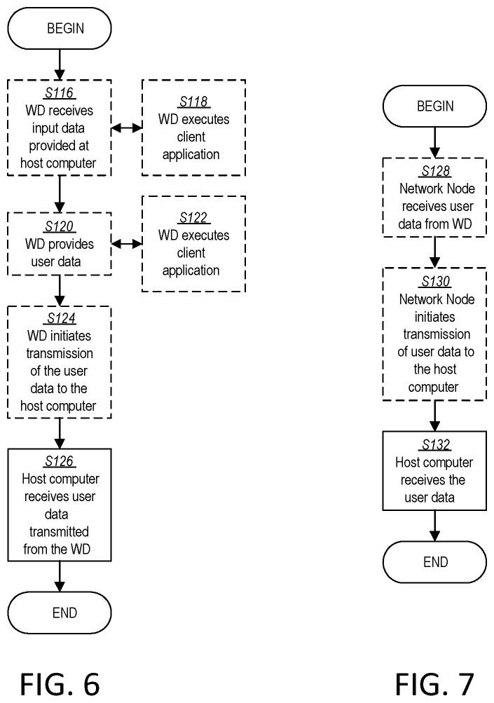

FIG. 6 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

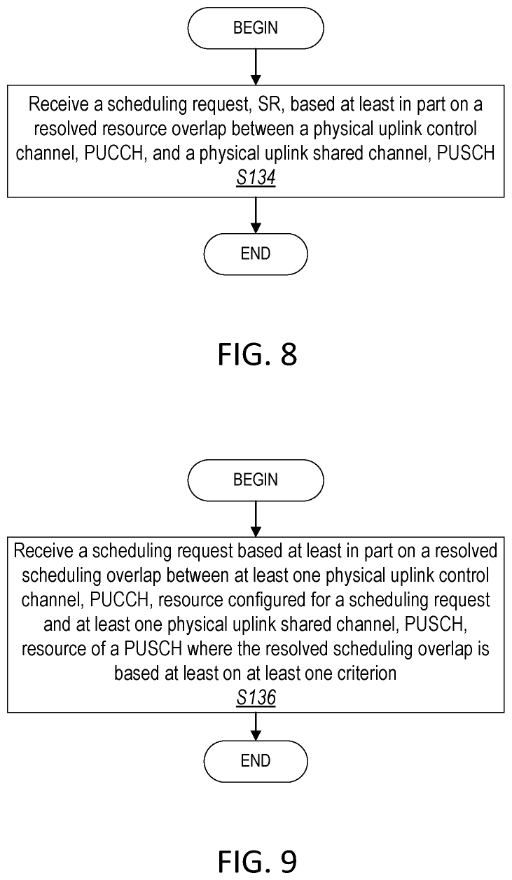

FIG. 8 is a flowchart of an example process in a network node 16 according to some embodiments of the disclosure. One or more Blocks and/or functions performed by network node 16 may be performed by one or more elements of network node 16 such as by request unit 32 in processing circuitry 68, processor 70, radio interface 62, etc. In one or more embodiments, network node 16 such as via one or more of processing circuitry 68, processor 70, communication interface 60 and radio interface 62 is configured to receive (Block S134) a scheduling request, SR, based at least in part on a resolved resource overlap between a physical uplink control channel, PUCCH, and a physical uplink shared channel, PUSCH.

According to one or more embodiments, at least part of the signaling on the PUSCH on the overlapping resources is dropped and the SR being received on the overlapping resources. According to one or more embodiments, at the SR is received along with Uplink Shared Channel, UL-SCH, signaling as part of a jointly processed transmission.

According to one or more embodiments, the jointly processed transmission corresponds to one of: the PUSCH being punctured to carry the SR on the overlapping resources, a DMRS of the PUSCH being punctured by the SR, the PUSCH being punctured to carry the SR on the overlapping resources, the DMRS of the PUSCH not being punctured by the SR, and the PUSCH being rate-matched around the SR on the overlapping resources, the DMRS of the PUSCH not being punctured.

FIG. 9 is a flowchart of another example process in a network node 16 according to some embodiments of the disclosure. One or more Blocks and/or functions performed by network node 16 may be performed by one or more elements of network node 16 such as by request unit 32 in processing circuitry 68, processor 70, radio interface 62, etc. In one or more embodiments, network node 16 such as via one or more of processing circuitry 68, processor 70, communication interface 60 and radio interface 62 is configured to receive (Block S136) a scheduling request based at least in part on a resolved scheduling overlap between at least one physical uplink control channel, PUCCH, resource configured for a scheduling request and at least one physical uplink shared channel, PUSCH, resource of a PUSCH where the resolved scheduling overlap is based at least on at least one criterion.

According to one or more embodiments, the at least one criterion is based at least on a priority level of a logical channel that triggered the scheduling request and a highest priority level of at least one logical channel on the PUSCH. According to one or more embodiments, the at least one criterion is based at least on a periodicity of the scheduling request and a periodicity of a grant for the PUSCH. According to one or more embodiments, the at least one criterion is met based on a periodicity of the scheduling request being lower than a periodicity of a grant for the PUSCH.

According to one or more embodiments, the at least one criterion is based at least on a joint processing time for processing the scheduling request and PUSCH. According to one or more embodiments, the at least one criterion is met based on there being sufficient time to multiplex the scheduling request onto the PUSCH. According to one or more embodiments, the scheduling request is multiplexed on the PUSCH based at least on a priority level of the scheduling request. According to one or more embodiments, one of: the scheduling request is multiplexed without other uplink control information, UCI, types based on the priority level; the scheduling request is multiplexed with a Hybrid automatic repeat request-acknowledgement, HARQ-ACK, based on a number of HARQ-ACK bits; and the scheduling request is multiplexed based on a PUCCH format of the PUCCH.

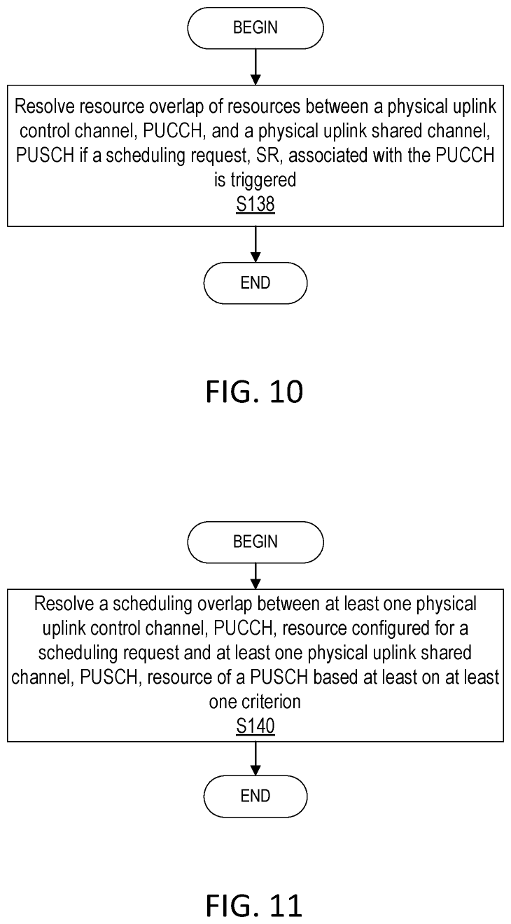

FIG. 10 is a flowchart of an example process in a wireless device 22 according to some embodiments of the present disclosure. One or more Blocks and/or functions performed by wireless device 22 may be performed by one or more elements of wireless device 22 such as by resolution unit 34 in processing circuitry 84, processor 86, radio interface 82, etc. In one or more embodiments, wireless device such as via one or more of processing circuitry 84, processor 86 and radio interface 82 is configured to resolve (Block S138) resource overlap of resources between a physical uplink control channel, PUCCH, and a physical uplink shared channel, PUSCH if a scheduling request, SR, associated with the PUCCH is triggered.

According to one or more embodiments, the resolving of the resource overlap between PUCCH and PUSCH includes one of: dropping the SR from transmission on the overlapping resources and transmitting signaling on the PUSCH on the overlapping resources; dropping at least part of the signaling on the PUSCH on the overlapping resources and transmitting the SR on the overlapping resources; and jointly processing the SR and Uplink Shared Channel, UL-SCH, for transmission on the overlapping resources.

According to one or more embodiments, dropping at least part of the signaling on the PUSCH on the overlapping resources and transmitting the SR on the overlapping resources includes one of: dropping all of the signaling on the PUSCH on overlapping resources and resuming the signaling on the PUSCH at a later time, dropping all of the signaling on the PUSCH on overlapping resources including Demodulation Reference Signal, DMRS, and dropping any subsequent PUSCH symbols, dropping all of the signaling on the PUSCH on overlapping resources and dropping any subsequent PUSCH symbols, the DMRS on the PUSCH on overlapping resources remaining for PUSCH transmission.

According to one or more embodiments, the joint processing of the SR and UL-SCH includes one of: puncturing the PUSCH to carry the SR on the overlapping resources, a DMRS of the PUSCH being punctured by the SR; puncturing the PUSCH to carry the SR on the overlapping resources, the DMRS of the PUSCH not being punctured by the SR; and rate-matching the PUSCH around the SR on the overlapping resources, the DMRS of the PUSCH not being punctured. According to one or more embodiments, the resolving of the resource overlap between the PUCCH and PUSCH is based at least in part on at least one of a size, position, periodicity and priority of the SR on the overlapping resources.

FIG. 11 is a flowchart of another example process in a wireless device 22 according to some embodiments of the present disclosure. One or more Blocks and/or functions performed by wireless device 22 may be performed by one or more elements of wireless device 22 such as by resolution unit 34 in processing circuitry 84, processor 86, radio interface 82, etc. In one or more embodiments, wireless device such as via one or more of processing circuitry 84, processor 86 and radio interface 82 is configured to resolve (Block S140) a scheduling overlap between at least one physical uplink control channel, PUCCH, resource configured for a scheduling request and at least one physical uplink shared channel, PUSCH, resource of a PUSCH based at least on at least one criterion, as described herein.

According to one or more embodiments, the resolving of the scheduling overlap includes one of dropping the scheduling request and causing transmission of the scheduling request. According to one or more embodiments, the at least one criterion is based at least on a priority level of a logical channel that triggered the scheduling request and a highest priority level of at least one logical channel on the PUSCH. According to one or more embodiments, the at least one criterion is based at least on a periodicity of the scheduling request and a periodicity of a grant for the PUSCH.

According to one or more embodiments, the at least one criterion is met based on a periodicity of the scheduling request being lower than a periodicity of a grant for the PUSCH. According to one or more embodiments, the scheduling overlap is resolved by dropping the scheduling request based the at least one criterion being met. According to one or more embodiments, the at least one criterion is based at least on a joint processing time for processing the scheduling request and PUSCH.

According to one or more embodiments, the at least one criterion is met based on there being sufficient time to multiplex the scheduling request onto the PUSCH. According to one or more embodiments, based on the at least one criterion being met, the processing circuitry is configured to one of: cancel the scheduling request and cause transmission of the PUSCH; and cancel transmission of at least a portion of the PUSCH and cause transmission of the scheduling request. According to one or more embodiments, the cancelling of the transmission of at least the portion of the PUSCH includes one of: cancelling the at least the portion of the PUSCH that includes overlapping symbols with scheduling request, the transmission of the PUSCH configured to resume after transmission of the scheduling request; cancelling the at least the portion of the PUSCH that includes overlapping symbols with the scheduling request and subsequent PUSCH symbols, the at least the portion of the PUSCH including a demodulation reference signal, DMRS; and cancelling the at least the portion of the PUSCH that includes overlapping symbols with the scheduling request and subsequent PUSCH symbols while preserving a DMRS for transmission.

According to one or more embodiments, the resolving the scheduling overlap includes the processing circuitry being configured to multiplex the scheduling request on the PUSCH based at least on a priority level of the scheduling request. According to one or more embodiments, one of: the scheduling request is multiplexed without other uplink control information, UCI, types based on the priority level; the scheduling request is multiplexed with a Hybrid automatic repeat request-acknowledgement, HARQ-ACK, based on a number of HARQ-ACK bits; and the scheduling request is multiplexed based on a PUCCH format of the PUCCH.

Having described the general process flow of arrangements of the disclosure and having provided examples of hardware and software arrangements for implementing the processes and functions of the disclosure, the sections below provide details and examples of arrangements for resolving a resource overlap between a physical uplink control channel (PUCCH) and a physical uplink shared channel (PUSCH) if a scheduling request (SR) has been triggered.

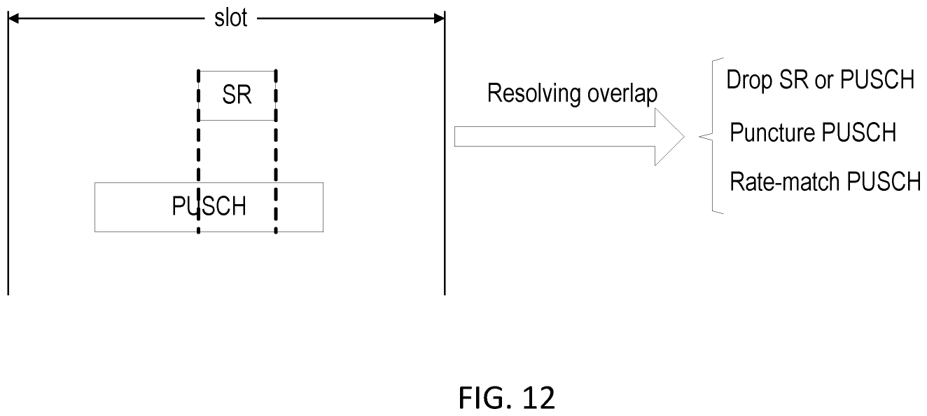

Embodiments provide resolving a resource overlap between a PUCCH and a PUSCH if a scheduling request (SR) has been triggered. Examples of solving a collision between SR in PUCCH and PUSCH are illustrated in FIG. 12.

If a positive SR is present (i.e., has been triggered) at the physical layer, there are two frameworks that SR can be sent in the presence of overlapping PUSCH where the PUSCH carries UL-SCH. In one or more embodiments, a positive SR refers to a scheduling request where a wireless device 22 is requesting to be scheduled, as opposed to a negative scheduling request where the wireless device 22 is requesting to not be scheduled. Several resolution techniques/methods are described below where the first framework is described in (A) and a second framework is described in (B).

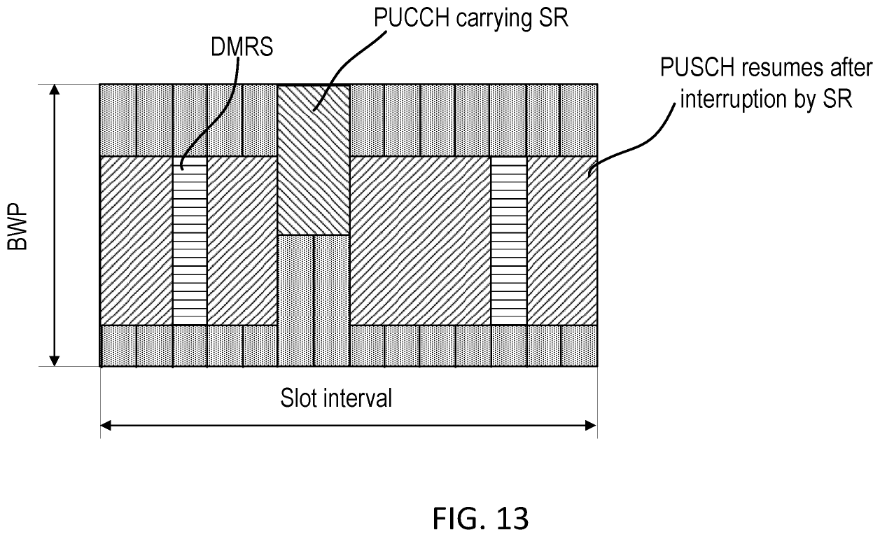

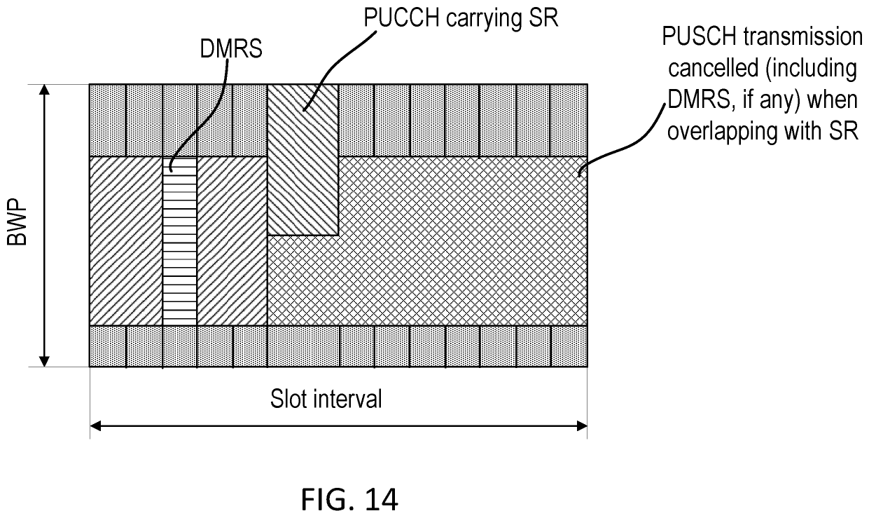

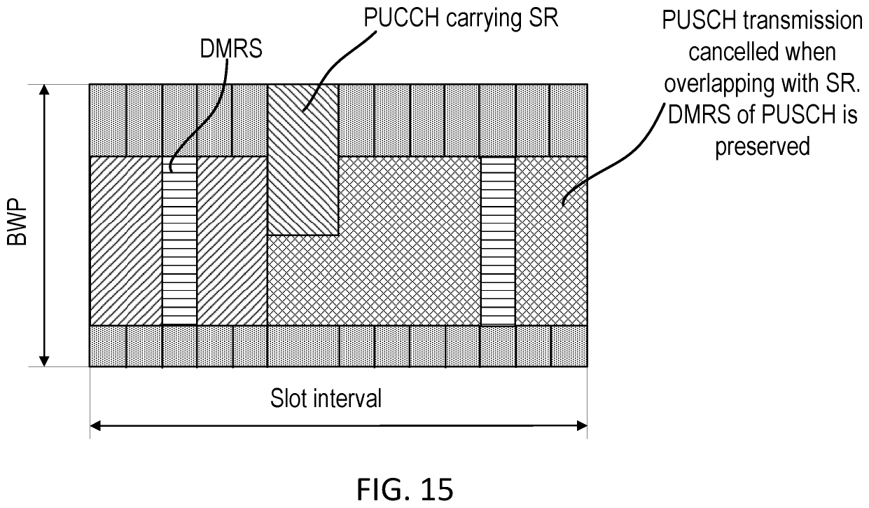

A. In the first example technique for one or more embodiments, once the SR is triggered by MAC (i.e., triggered by the MAC layer), the positive SR bit is sent via PUCCH, and the resource overlapping in time between PUCCH and PUSCH is handled at the physical layer. The PUCCH resource is determined by the SR configuration of RRC. This framework may apply when there is no sufficient time (e.g., time (i.e., joint processing time) for performing an action is below a threshold which may be consider an example of a criterion) for the wireless device 22 to jointly process SR bits and UL-SCH bits, for example, when the wireless device 22 timeline does not permit multiplexing SR onto PUSCH carrying PUCCH. In other words, the PUCCH is already formed such that multiplexing of the SR onto the PUSCH may not be permitted where the PUCCH being formed may correspond to where resources have been scheduled in the PUCCH and/or PUCCH data has been coded to symbols such that the scheduling/mapping/coding for the PUCCH has been performed. Under this framework, there are two techniques to resolve the resource overlapping in time between PUCCH and PUSCH:
(1) SR is dropped and PUSCH is kept. In one or more embodiments, the wireless device 22 such as via one or more of processing circuitry 84, radio interface 82, resolution unit 34, etc. drops the SR from transmission on the overlapping resources and transmits/causes transmission of signaling on the PUSCH on the overlapping resources
(2) Part or all of the PUSCH dropped and SR is kept. Furthermore, several ways of cancelling part of the PUSCH transmissions are illustrated in FIGS. 13, 14 and 15, respectively. For example, in one or more embodiments, the wireless device 22 such as via one or more of processing circuitry 84, radio interface 82, resolution unit 34, etc. is configured to drop at least part of the signaling on the PUSCH on the overlapping resources and transmits/cause transmission on the SR on the overlapping resources. The following are three example techniques for A(2).
   a. Referring to FIG. 13, the PUCCH carrying SR cancels PUSCH transmission in the overlapping symbols, but the PUSCH transmission resumes afterwards. For example, in one or more embodiments, the wireless device 22 such as via such as via one or more of processing circuitry 84, radio interface 82, resolution unit 34, etc. drops all of the signaling on the PUSCH on overlapping resources and resumes the signaling on the PUSCH at a later time
   b. Referring to FIG. 14, the PUCCH carrying SR cancels PUSCH transmission including DMRS of PUSCH (if any), in the overlapping symbols and any subsequent PUSCH symbols. For example, in one or more embodiments, the wireless device 22 such as via such as via one or more of processing circuitry 84, radio interface 82, resolution unit 34, etc. drops all of the signaling on the PUSCH on overlapping resources including Demodulation Reference Signal, DMRS, and drops any subsequent PUSCH symbols.
   c. In FIG. 15, the PUCCH carrying SR cancels PUSCH transmission in the overlapping symbols and any subsequent PUSCH symbols. DMRS of PUSCH, which would otherwise be cancelled as in (2b), is preserved instead. Preservation of DMRS allows the network node 16 to detect that the wireless device 22 had made an attempt to transmit PUSCH, even though the data portion of PUSCH may be too severely interrupted to allow correct decoding of UL-SCH. For example, in one or more embodiments, the wireless device 22 drops all of the signaling on the PUSCH on overlapping resources and drops any subsequent PUSCH symbols where the DMRS on the PUSCH on overlapping resources remains for PUSCH transmission.

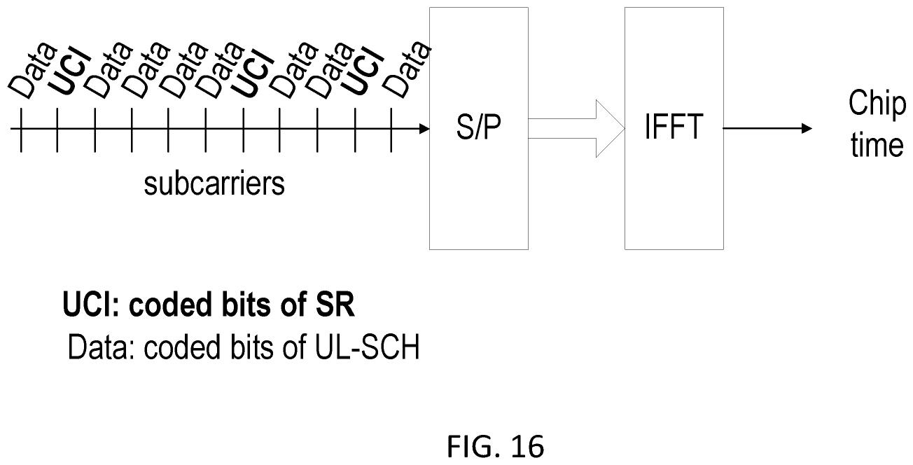

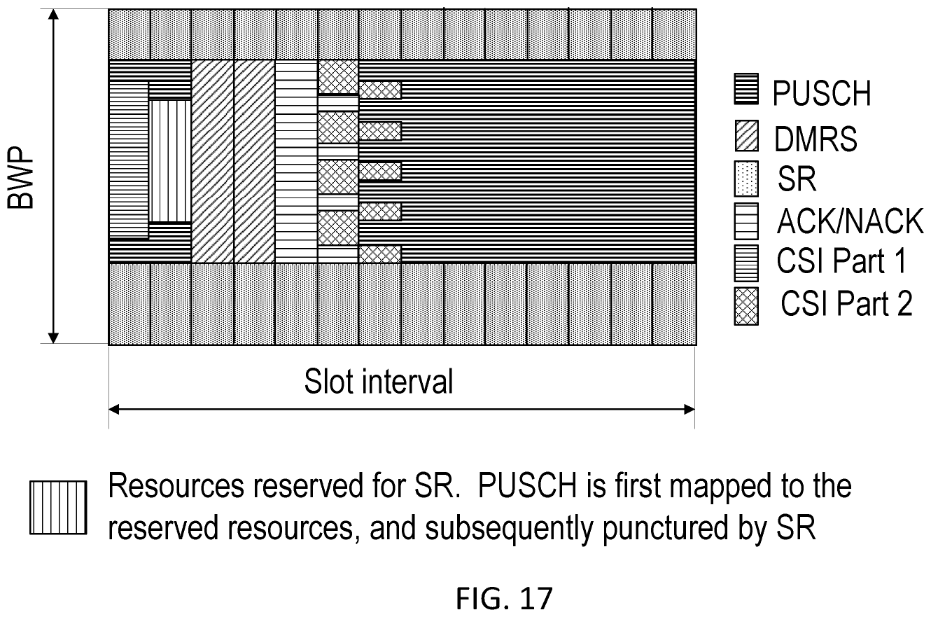

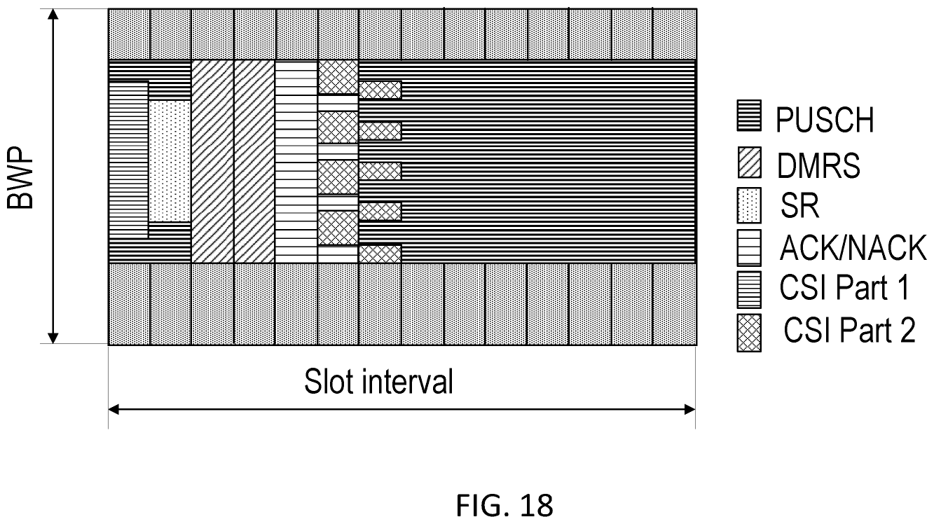

B. In another example technique, once the SR is triggered by MAC, the positive SR bit is mapped to a sequence of SR coded bits (i.e., channel encoding procedure). Then the sequence of SR coded bits is multiplexed with other coded bit of UCI (if any) and UL-SCH to generate the multiplexed data and control coded bit sequence, which is then used to produce the sequence of modulation symbols and mapped to resource elements. In other words, the PUCCH is not yet formed such that multiplexing of the SR onto the PUSCH is permitted. This procedure is illustrated in FIG. 16. For example, in one or more embodiments, the wireless device 22 such as via such as via one or more of processing circuitry 84, radio interface 82, resolution unit 34, etc. jointly processes the SR and Uplink Shared Channel, UL-SCH, for transmission on the overlapping resources. Note that in general the UL-SCH may or may not be present when the UCI bits are carried by PUSCH, but it is assumed that UL-SCH exist in this discussion. This framework is possible when the wireless device 22 processing timeline allows the wireless device 22 to jointly process SR bits and UL-SCH bits. Under this technique, there are several subsets of techniques to resolve the resource overlapping in time between PUCCH and PUSCH:
(1) PUSCH is punctured to carry SR and DMRS of PUSCH is punctured. For example, in one or more embodiments, the wireless device 22 such as via such as via one or more of processing circuitry 84, radio interface 82, resolution unit 34, etc. punctures the PUSCH to carry the SR on the overlapping resources where a DMRS of the PUSCH is punctured by the SR.
(2) PUSCH is punctured to carry SR and DMRS of PUSCH is not punctured. This is illustrated in FIG. 17. As shown in FIG. 16, there can be other types of UCI (ACK/NACK, Channel State Information (CSI) Part 1, CSI Part 2) that is multiplexed with the PUSCH. In one or more embodiments, the coded bits of SR are mapped to the OFDM symbol(s) adjacent to the DMRS symbols. For example, in one or more embodiments, the wireless device 22 such as via such as via one or more of processing circuitry 84, radio interface 82, resolution unit 34, etc. punctures the PUSCH to carry the SR on the overlapping resources where the DMRS of the PUSCH is not punctured by the SR.
(3) PUSCH is rate-matched around resource(s) for SR, and DMRS of PUSCH is not punctured. This is illustrated in FIG. 18. As shown in FIG. 18, there can be other types of UCI (ACK/NACK, CSI Part 1, CSI Part 2) that are multiplexed with the PUSCH. In one or more embodiments, the coded bits of SR are mapped to the OFDM symbol(s) adjacent to the DMRS symbols. For example, in one or more embodiments, the wireless device 22 such as via such as via one or more of processing circuitry 84, radio interface 82, resolution unit 34, etc. rate-matches the PUSCH around the SR on the overlapping resources where the DMRS of the PUSCH is not punctured.

Which method and/or embodiment, i.e., technique from A and/or B above, to select may depend on one or more of the size, position, periodicity and priority of SR resources which may be considered examples of at least one criterion. As one example, if SR has a duration of only one symbol and PUSCH is spread over multiple symbols, then PUSCH can be punctured to carry SR simultaneously. Another example is if SR belongs to a time critical transmission (high priority transmission) and PUSCH has lower priority, then PUSCH might be dropped. Another example is when PUSCH carries high priority data, and to avoid error in data transmission, PUSCH can be rate matched around SR and both are transmitted. Therefore, in one or more embodiments, the resolving of the resource overlap between the PUCCH and PUSCH is based at least in part on at least one of a size, position, periodicity and priority of the SR on the overlapping resources.

In one or more embodiments, whether the UL-SCH is on a configured grant or not also impacts which resolution technique (i.e., A and/or, B and/or and sub-technique within A and/or B above) is used/implemented. A configured grant may correspond to semi-persistent scheduling which be non-requested grants send to the wireless device 22 such as to allow the wireless device 22 to make the decision whether or not to use the non-requested grant.

For example, assume that the UL-SCH transmission is on a configured grant. The wireless device 22 assumes correct reception by network node 16 if the wireless device 22 did not receive a DCI for a retransmission dynamic grant from network node 16, within the ConfiguredGrantTimer period.

A problem (i.e., configured grant problem) may arise in that the network node 16 might not be aware of a transmission on the configured grant if the transmission of the configured grant is not detected at the network node 16. In addition, the wireless device 22 may be allowed to skip the configured grant transmission in case of empty buffer. Hence, the network node 16 may not be able to determine the difference between the following two cases 1) wireless device 22 transmits on the configured grant, but the transmission is cancelled at PHY due to another overlapping grant; 2) wireless device 22 has empty buffer and determines not to transmit on the configured grant. For example, the network node 16 may consider an absence of an uplink transmission as a decision that the wireless device 22 chose not the transmit on the configured grant as opposed to the wireless device 22 transmitting on the configured grant but the network node 16 failing to detect/decode the transmission

For case 1), the network node 16 may need to send a retransmission UL grant within the ConfiguredGrantTimer period. Otherwise, the data on that configured grant may be lost. For case 2), the network node 16 may not need to respond.

In a follow-up embodiment, the same conditions for a configured grant are applied to the case of dynamic grant while skip UplinkTxDynamic in RRC Information Element (IE) MAC-CellGroupConfig is set to be true. The reason is that the above problem is due to wireless device 22 skip transmission when wireless device 22 buffer is empty. If skip UplinkTxDynamic is set to be true, then wireless device 22 also skips transmission on a dynamic grant when the wireless device 22 buffer is empty. In what follows, for the ease of discussion, only configured grant is described and when “dynamic grant” is referenced, it refers to both cases that skip UplinkTxDynamic is set to be either true or false.

Delivery of the SR is Decided at MAC Layer—One Possible Solution to the Configured Grant Problem Described Above

In this section, whether pending SR is sent to PHY (i.e., physical layer) for transmission is decided at MAC (i.e., MAC layer), e.g., one solution is to compare the priority of the LCH that triggers the SR and the highest priority of the LCH(s) on the UL-SCH which may be considered an example of at least one criterion. For example, in one or more embodiments, one method involves comparing the priority of the Logical Channel (LCH) that triggers the SR with the highest priority of the LCH(s) on the UL-SCH. In addition, the wireless device 22 might already be transmitting on the UL-SCH or is about to transmit on the UL-SCH. Sending SR on an overlapping UL-SCH resource may be allowed, if the priority of the LCH that triggers the SR is higher than the highest priority of the LCH(s) to be transmitted or is under transmission on the UL-SCH resource.

In one embodiment, if the UL-SCH resource is a configured grant, the resolution technique is chosen such that the network node 16 is able to detect that there is a transmission on the UL-SCH resource and SR is detected. Therefore, the candidate resolution techniques are (2c), (4) and (5): 2(c), as described above, where the PUCCH carrying SR cancels the data-portion of PUSCH but preserves DMRS of PUSCH; (4) where PUSCH is punctured to carry SR and DMRS part of PUSCH is not punctured; and (5) where PUSCH is rate-matched around the coded sequence of SR. In other words, the resolution techniques (1),(2a), (2b),(3) above may not be suitable for this situation.

In another embodiment, if the UL-SCH resource is a configured grant, the resolution technique is chosen such that the network node 16 may not be able to detect there is a transmission on the UL-SCH resource. For example, the DMRS of PUSCH is also punctured by SR or PUSCH is dropped completely. In these cases, an indication that the UL-SCH is lost may be needed. The indication can be either locally in the wireless device 22 side from PHY to MAC or sent through the air-interface from the wireless device 22 to network node 16 in a MAC CE.

In a follow-up embodiment, if the UL-SCH resource is a dynamic grant, then the resolution technique from the techniques described above may be selected such that SR is detected (e.g., above techniques A and B and the techniques described within A and B).

Delivery of the SR is Jointly Decided by PHY and MAC Layer

According to one or more embodiments, if SR is triggered with resources that collide with an UL data transmission that is scheduled by UL grant DCI (dynamically scheduled transmission), then SR may be delivered to the physical layer for transmission.

According to one or more embodiments, if SR is triggered with resources that collide with an UL data transmission with configured grant, then whether SR is delivered to the physical layer for transmission depends on whether it collides with DMRS symbols of PUSCH resources, which may be considered an example of at least one criterion.

According to one or more embodiments, if the resources for SR overlaps with the DMRS resources for PUSCH, then SR is dropped. One reason for this behavior is that if DMRS is punctured, then it is possible that the network node 16 is not aware that there is UL transmission in the configured grant.

One or more embodiments involve when SR with low periodicity (i.e., more frequent) collides with a configured grant PUSCH with high periodicity (i.e., less frequent), which may be considered an example of at least one criterion. In this case, SR is dropped in favor of transmission with less frequent resources. The opposite can be used (e.g., CG PUSCH is dropped) if SR with high periodicity collides with configured grant PUSCH with low periodicity.

Construction of the PUCCH Carrying a High Priority SR

When multiple UCI types are available (e.g., SR, HARQ-ACK, CSI) after checking the wireless device 22 processing timeline, they are usually multiplexed before transmission on PUCCH, as described in 3GPP Rel-15. This may be reasonable when the SR is not differentiated by high vs low priority at physical layer.

When the priority level of SR is known at the physical layer, as is expected in wireless communication standards such as 3GPP Rel-16 and later, the high-priority SR is preferably treated differently than low-priority SR at the physical layer.

In one or more embodiments, a high priority SR is not multiplexed with any other UCI types for PUCCH transmission. Additionally, only positive SR is transmitted, while negative SR is not transmitted.

In one or more embodiments, a high priority SR can be multiplexed with HARQ-ACK if the number of HARQ-ACK bits are small, e.g., 0 or 1 or 2 (i.e., <=2) HARQ-ACK bits.

In one or more embodiments, if and how to multiplex a high priority SR with other UCI types may depend on the PUCCH resource configured for SR. If the PUCCH resource configured for the SR is PUCCH format 0, then at most two UCI bits can be carried. In this case, the high priority SR can be multiplexed with zero or one HARQ-ACK bit. On the other hand, if the PUCCH resource configured for the SR is PUCCH format 2, then more than two UCI bits can be carried. In this case, the high priority SR can be multiplexed with a small number of HARQ-ACK bits, possibly even a few high priority CSI bits.

### Some Examples

Example A1. A network node 16 configured to communicate with a wireless device 22 (WD 22), the network node 16 configured to, and/or comprising a radio interface 62 and/or comprising processing circuitry 68 configured to:

receive a scheduling request, SR, based at least in part on a resolved resource overlap between a physical uplink control channel, PUCCH, and a physical uplink shared channel, PUSCH.

Example A2. The network node 16 of Example A1, wherein at least part of the signaling on the PUSCH on the overlapping resources is dropped and the SR being received on the overlapping resources.

Example A3. The network node 16 of Example A1, wherein the SR is received along with Uplink Shared Channel, UL-SCH, signaling as part of a jointly processed transmission.

Example A4. The network node 16 of Example A3, wherein the jointly processed transmission corresponds to one of:

the PUSCH being punctured to carry the SR on the overlapping resources, a DMRS of the PUSCH being punctured by the SR;

the PUSCH being punctured to carry the SR on the overlapping resources, the DMRS of the PUSCH not being punctured by the SR; and

the PUSCH being rate-matched around the SR on the overlapping resources, the DMRS of the PUSCH not being punctured.

Example B1. A method implemented in a network node 16 that is configured to communicate with a wireless device 22, the method comprising:

receiving a scheduling request, SR, based at least in part on a resolved resource overlap between a physical uplink control channel, PUCCH, and a physical uplink shared channel, PUSCH.

Example B2. The method of Example B1, wherein at least part of the signaling on the PUSCH on the overlapping resources is dropped and the SR being received on the overlapping resources.

Example B3. The method of Example B1, wherein the SR is received along with Uplink Shared Channel, UL-SCH, signaling as part of a jointly processed transmission.

Example B4. The method of Example B3, wherein the jointly processed transmission corresponds to one of:

the PUSCH being punctured to carry the SR on the overlapping resources, a DMRS of the PUSCH being punctured by the SR;

the PUSCH being punctured to carry the SR on the overlapping resources, the DMRS of the PUSCH not being punctured by the SR; and

the PUSCH being rate-matched around the SR on the overlapping resources, the DMRS of the PUSCH not being punctured.

Example C1. A wireless device 22 (WD 22) configured to communicate with a network node, the WD 22 configured to, and/or comprising a radio interface 82 and/or processing circuitry 84 configured to:

resolve resource overlap of resources between a physical uplink control channel, PUCCH, and a physical uplink shared channel, PUSCH if a scheduling request, SR, associated with the PUCCH is triggered.

Example C2. The WD 22 of Example C1, wherein the resolving of the resource overlap between PUCCH and PUSCH includes one of:

dropping the SR from transmission on the overlapping resources and transmitting signaling on the PUSCH on the overlapping resources;

dropping at least part of the signaling on the PUSCH on the overlapping resources and transmitting the SR on the overlapping resources; and

jointly process the SR and Uplink Shared Channel, UL-SCH, for transmission on the overlapping resources.

Example C3. The WD 22 of Example C2, wherein dropping at least part of the signaling on the PUSCH on the overlapping resources and transmitting the SR on the overlapping resources includes one of:

dropping all of the signaling on the PUSCH on overlapping resources and resuming the signaling on the PUSCH at a later time;

dropping all of the signaling on the PUSCH on overlapping resources including Demodulation Reference Signal, DMRS, and dropping any subsequent PUSCH symbols; and

dropping all of the signaling on the PUSCH on overlapping resources and dropping any subsequent PUSCH symbols, the DMRS on the PUSCH on overlapping resources remaining for PUSCH transmission.

Example C4. The WD 22 of Example C3, wherein the joint processing of the SR and UL-SCH includes one of:

puncturing the PUSCH to carry the SR on the overlapping resources, a DMRS of the PUSCH being punctured by the SR;

puncturing the PUSCH to carry the SR on the overlapping resources, the DMRS of the PUSCH not being punctured by the SR; and

rate-matching the PUSCH around the SR on the overlapping resources, the DMRS of the PUSCH not being punctured.

Example C5. The WD 22 of any one of Examples C1-C4, wherein the resolving of the resource overlap between the PUCCH and PUSCH is based at least in part on at least one of a size, position, periodicity and priority of the SR on the overlapping resources.

Example D1. A method implemented in a wireless device 22 (WD 22) that is configured to communicate with a network node 16, the method comprising:

resolving resource overlap of resources between a physical uplink control channel, PUCCH, and a physical uplink shared channel, PUSCH if a scheduling request, SR, associated with the PUCCH is triggered.

Example D2. The method of Example D1, wherein the resolving of the resource overlap between PUCCH and PUSCH includes one of:

dropping the SR from transmission on the overlapping resources and transmitting signaling on the PUSCH on the overlapping resources;

dropping at least part of the signaling on the PUSCH on the overlapping resources and transmitting the SR on the overlapping resources; and

jointly process the SR and Uplink Shared Channel, UL-SCH, for transmission on the overlapping resources.

Example D3. The method of Example D1, wherein dropping at least part of the signaling on the PUSCH on the overlapping resources and transmitting the SR on the overlapping resources includes one of:

dropping all of the signaling on the PUSCH on overlapping resources and resuming the signaling on the PUSCH at a later time;

dropping all of the signaling on the PUSCH on overlapping resources including Demodulation Reference Signal, DMRS, and dropping any subsequent PUSCH symbols; and

dropping all of the signaling on the PUSCH on overlapping resources and dropping any subsequent PUSCH symbols, the DMRS on the PUSCH on overlapping resources remaining for PUSCH transmission.

Example D4. The method of Example D1, wherein the joint processing of the SR and UL-SCH includes one of:

puncturing the PUSCH to carry the SR on the overlapping resources, a DMRS of the PUSCH being punctured by the SR;

puncturing the PUSCH to carry the SR on the overlapping resources, the DMRS of the PUSCH not being punctured by the SR; and

rate-matching the PUSCH around the SR on the overlapping resources, the DMRS of the PUSCH not being punctured.

Example D5. The method of Example D1, wherein the resolving of the resource overlap between the PUCCH and PUSCH is based at least in part on at least one of a size, position, periodicity and priority of the SR on the overlapping resources.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

eMBB enhanced Mobile BroadBand

LTE Long Term Evolution

NR Next Radio

PUCCH Physical Uplink Control Channel

PUSCH Physical Uplink Shared Channel

SR Scheduling Request

URLLC Ultra-Reliable Low Latency Communication

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node, the wireless device comprising:
processing circuitry configured to:
resolve a scheduling overlap between at least one physical uplink control channel, PUCCH, resource configured for a scheduling request and at least one physical uplink shared channel, PUSCH, resource of a PUSCH based at least on at least one criterion.

2. The wireless device of claim 1, wherein the resolving of the scheduling overlap includes one of dropping the scheduling request and causing transmission of the scheduling request.

3. The wireless device of claim 1, wherein the at least one criterion is based at least on a priority level of a logical channel that triggered the scheduling request and a highest priority level of at least one logical channel on the PUSCH.

4. The wireless device of claim 1, wherein the at least one criterion is based at least on a periodicity of the scheduling request and a periodicity of a grant for the PUSCH.

5. The wireless device of claim 4, wherein the at least one criterion is met based on a periodicity of the scheduling request being lower than a periodicity of a grant for the PUSCH.

6. The wireless device of claim 5, wherein the scheduling overlap is resolved by dropping the scheduling request based the at least one criterion being met.

7. The wireless device of claim 1, wherein the at least one criterion is based at least on a joint processing time for processing the scheduling request and PUSCH.

8. The wireless device of claim 7, wherein the at least one criterion is met based on there being sufficient time to multiplex the scheduling request onto the PUSCH.

9. The wireless device of claim 8, wherein based on the at least one criterion being met, the processing circuitry is configured to one of:
cancel the scheduling request and cause transmission of the PUSCH; and
cancel transmission of at least a portion of the PUSCH and cause transmission of the scheduling request.

10. The wireless device of claim 9, wherein the cancelling of the transmission of at least the portion of the PUSCH includes one of:
cancelling the at least the portion of the PUSCH that includes overlapping symbols with scheduling request, the transmission of the PUSCH configured to resume after transmission of the scheduling request;
cancelling the at least the portion of the PUSCH that includes overlapping symbols with the scheduling request and subsequent PUSCH symbols, the at least the portion of the PUSCH including a demodulation reference signal, DMRS; and
cancelling the at least the portion of the PUSCH that includes overlapping symbols with the scheduling request and subsequent PUSCH symbols while preserving a DMRS for transmission.

11. The wireless device of claim 1, wherein the resolving the scheduling overlap includes the processing circuitry being configured to multiplex the scheduling request on the PUSCH based at least on a priority level of the scheduling request.

12. The wireless device of claim 11, wherein one of:
the scheduling request is multiplexed without other uplink control information, UCI, types based on the priority level;
the scheduling request is multiplexed with a Hybrid automatic repeat request-acknowledgement, HARQ-ACK, based on a number of HARQ-ACK bits; and
the scheduling request is multiplexed based on a PUCCH format of the PUCCH.

13.-20. (canceled)

21. A method implemented by a wireless device that is configured to communicate with a network node, the method comprising:
resolving a scheduling overlap between at least one physical uplink control channel, PUCCH, resource configured for a scheduling request and at least one physical uplink shared channel, PUSCH, resource of a PUSCH based at least on at least one criterion.

22. The method of claim 21, wherein the resolving of the scheduling overlap includes one of dropping the scheduling request and causing transmission of the scheduling request.

23. The method of claim 21, wherein the at least one criterion is based at least on a priority level of a logical channel that triggered the scheduling request and a highest priority level of at least one logical channel on the PUSCH.

24. The method of claim 21, wherein the at least one criterion is based at least on a periodicity of the scheduling request and a periodicity of a grant for the PUSCH.

25. The method of claim 24, wherein the at least one criterion is met based on a periodicity of the scheduling request being lower than a periodicity of a grant for the PUSCH.

26. The method of claim 25, wherein the scheduling overlap is resolved by dropping the scheduling request based the at least one criterion being met.

27. The method of claim 21, wherein the at least one criterion is based at least on a joint processing time for processing the scheduling request and PUSCH.

28. The method of claim 27, wherein the at least one criterion is met based on there being sufficient time to multiplex the scheduling request onto the PUSCH.

29. The method of claim 28, wherein based on the at least one criterion being met, the method further comprising one of:
cancelling the scheduling request and cause transmission of the PUSCH; and
cancelling transmission of at least a portion of the PUSCH and cause transmission of the scheduling request.

30. The method of claim 29, wherein the cancelling of the transmission of at least the portion of the PUSCH includes one of:
cancelling the at least the portion of the PUSCH that includes overlapping symbols with scheduling request, the transmission of the PUSCH configured to resume after transmission of the scheduling request;
cancelling the at least the portion of the PUSCH that includes overlapping symbols with the scheduling request and subsequent PUSCH symbols, the at least the portion of the PUSCH including a demodulation reference signal, DMRS; and
cancelling the at least the portion of the PUSCH that includes overlapping symbols with the scheduling request and subsequent PUSCH symbols while preserving a DMRS for transmission.

31. The method of claim 21, wherein the resolving the scheduling overlap includes the processing circuitry being configured to multiplex the scheduling request on the PUSCH based at least on a priority level of the scheduling request.

32. The method of claim 31, wherein one of:
the scheduling request is multiplexed without other uplink control information, UCI, types based on the priority level;
the scheduling request is multiplexed with a Hybrid automatic repeat request-acknowledgement, HARQ-ACK, based on a number of HARQ-ACK bits; and
the scheduling request is multiplexed based on a PUCCH format of the PUCCH.

33.-40. (canceled)
